(19) United States
(12) Patent Application Publication
(10) Pub. No.: US 2003/0177702 A1
(43) Pub. Date: Sep. 25, 2003

(54) Door shell for a motor vehicle door, profile frame for a door shell and process for the production of a profile frame for a door shell

(76) Inventors: Michael Hock, Grossostheim (DE); Stefan Marutschke, Radgau (DE)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/364,822

(22) Filed: Feb. 11, 2003

(30) Foreign Application Priority Data
Feb. 13, 2002 (DE) DE10206090.8
Apr. 20, 2002 (DE) DE10217713.9

(51) Int. Cl. B60J 5/04

(52) U.S. Cl. 49/502

(57) ABSTRACT

A door shell for a motor vehicle door with a one-piece or multi-piece profile frame of metal. The profile frame has a profile cross-section changing over the length of the profile frame at least in sections, in particular in the region of an edge of the door shell running essentially vertically. Preferably the profile frame has a hollow chamber and in particular this hollow chamber has a profile cross-section that changes over the length of the profile frame. Further preferably the profile frame is designed as an extruded profile of a light metal or light metal compound, in particular aluminium or an aluminium compound, as a tube of a light metal or light metal compound, in particular aluminium or an aluminium compound welded on a longitudinal seam, as a tube of steel welded on a longitudinal seam or as a tube of steel produced seamless. The profile cross-section of the profile frame is adapted to and follows the form of the inside door panel.

### CROSS-REFERENCE TO RELATED APPLICATIONS

This application claims priority from German Patent Application No. DE10206090.8, filed Feb. 13, 2002, and from German Patent Application No. DE10217713.9, filed Apr. 20, 2002, both incorporated herein by reference.

### BACKGROUND AND SUMMARY

The subject matter of the invention is in the first place a door shell for a motor vehicle door with a profile frame of metal. The subject matter of the invention is also such a profile frame for a door shell of a motor vehicle door. The subject matter of the invention is finally a special production process for such a profile frame.

Constantly increasing demands on vehicle doors in terms of reducing gap widths, dimensional accuracy of functional areas, repeat accuracy etc. represent a constant challenge for production processes. At the same time, mounting requirements on motor vehicle doors have to be taken into account, in particular the rigidity of the door frame in respect of wind pull-off forces, door sag etc.

The problem underlying the teaching is to improve a door shell in the problem area explained above, to indicate an appropriate profile frame and to indicate a process by which such a profile frame can be produced particularly expediently.

The teaching solves the problem explained above by the fact that the profile frame has a profile cross-section changing over the length of the profile frame at least in sections, in particular in the region of the B-pillar of a motor vehicle body. The same applies to a profile frame as a semi-finished product for the construction of a door shell. With regard to the production of such a profile frame, it is recommended to produce the desired profile cross-section changing over the length of the profile frame with the aid of a hydraulic internal high-pressure forming process.

The teaching of the present patent application can be extensively elaborated and developed in all aspects, for which purpose all the suggestions in the following text are given for the explanation of the examples of embodiment.

Already at this point, it can be pointed out that the effect of the optimisation of the door shell is that a jointing technique of bonding by means of a structural adhesive can be used more than hitherto in places where preference had to be given in the past to the jointing techniques of welding and beading. This in turn means that the product requirements can be more readily complied with, because component distortion and component tolerances are more easily complied with. The thermal load on components during welding can more often be dispensed with in the production sequence.

### BRIEF DESCRIPTION OF THE DRAWINGS

FIG. 1 shows, diagrammatically, the structure of a door shell of a motor vehicle door, here the left-hand front side door.

FIG. 2 shows a motor vehicle body indicating the profile frames of the motor vehicle doors.

FIG. 3 shows, diagrammatically, a motor vehicle door, sections Y-Y and Z-Z of the motor vehicle door, which here is constructed conventionally.

FIG. 4 shows, diagrammatically, a motor vehicle door, sections X-X, Y-Y and Z-Z in respect of this motor vehicle door, which is constructed according to the invention.

FIG. 5 shows by way of an example a profile frame for a motor vehicle door which is constructed as one-piece aluminium die cast part.

FIG. 6 by way of an example a three-piece profile frame having an aluminium die cast part towards the A-pillar and another die cast part towards the B-pillar and a conventional aluminium extruded profile in between.

### DETAILED DESCRIPTION OF THE INVENTION

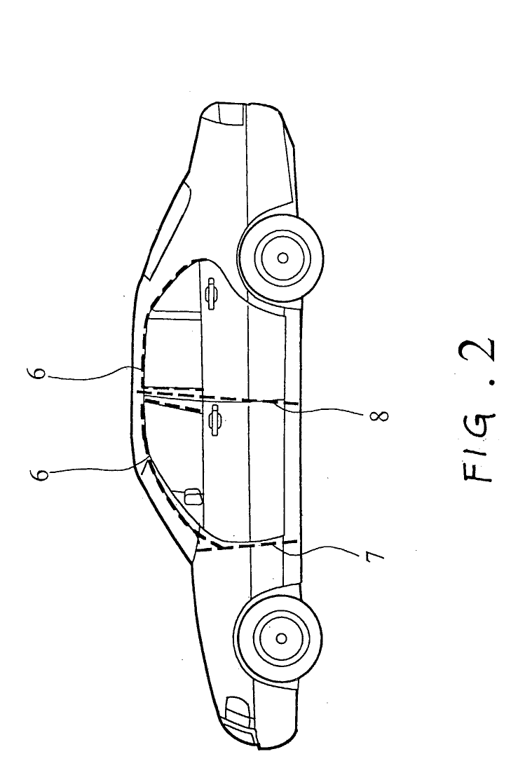

One-part inside door panels 1 are often used in motor vehicle doors, for example for a standard four-door sedan (FIG. 2). On the outside, one-part inside door panel 1 is provided with an outside door panel 2 extending up to the windowsill. An additional component in the form of a frame part 3 is used at least in the region of the window area. This additional frame part 3 stiffens the motor vehicle door, so that it meets the requirements in practice. A further stiffening of the door shell is achieved by means of an inner window sill profile 4 and an additional side impact protection profile 5 (outer window sill profile).

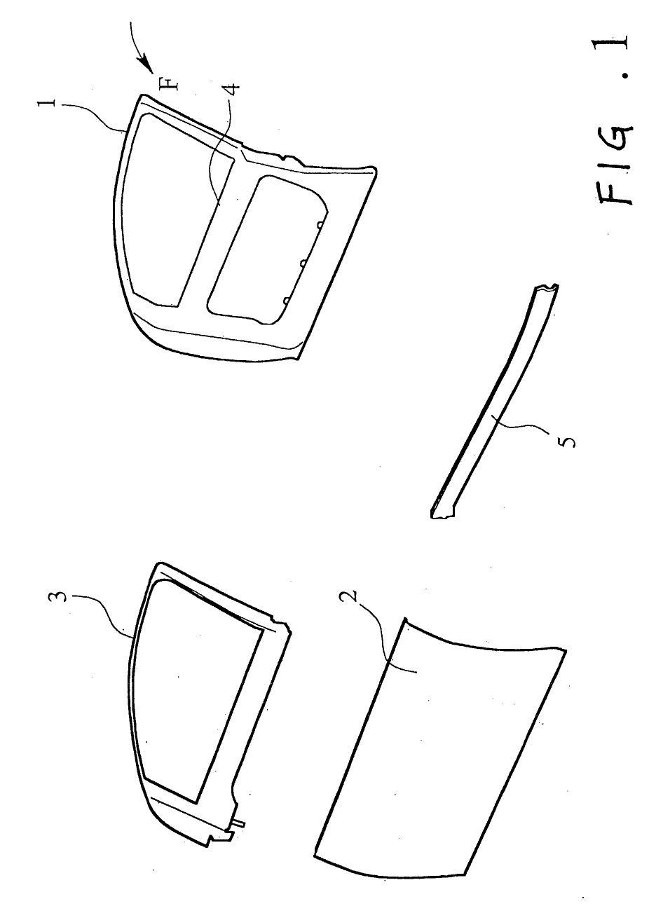

In FIG. 1 arrow F indicates the direction in which wind pull-off forces are loading the upper of the motor vehicle door.

FIG. 2 shows the side view of a motor vehicle and the region there that has to be specially reinforced in view of the wind pull-off forces and other influences in practice, region 6, the connection of the front side door to A-pillar 7 and the connection of the rear side door to B-pillar 8.

The motor vehicle door in the lower region, i.e. in the region of outer door panel 1, is firmly anchored in the doorframe by hinges and lock. The wind pull-off forces act in the upper region, i.e. in the region of the window area. If, for example, a manufacturer specifies a value of elastic deformation under certain conditions, this must be adhered to irrespective of the material from which the door shell is produced. Depending on the material used, however, the modulus of elasticity (Emodulus) differs greatly. In the case of steel, the E-modulus lies in the order of magnitude of 210,000 N/mm², in the case of aluminium in the order of magnitude of 70,000 N/mm². A construction of the door shell of steel with a profile frame of steel must be structurally different from a door shell of aluminium with a profile frame of aluminium. Nonetheless, the same values for elastic deformation have to be achieved.

The door shell of a motor vehicle door of steel exhibits, especially in the region of frame part 3, preferably stretch-bent roll-type profiles, which often have an L-shaped or U-shaped cross-section. Corresponding pressed parts are also used in combination with inner door panel 1. These components are assembled individually or also as a subassembly together with inner door panel 1, and dependent of the type of construction of the vehicle door, with outer door panel 2 to form the complete door shell. The window sill reinforcement 5 also has an additional structural function as does frame part 3, which routinely serves to reinforce the frame formed by inner door panel 1 in the region of the window area.

It results from the interrelationship described above (E-modulus) that frame part 3 normally consists of simple pressed parts in the case of a steel door and is adequately dimensioned in the previously described shape forming a desired hollow chamber.

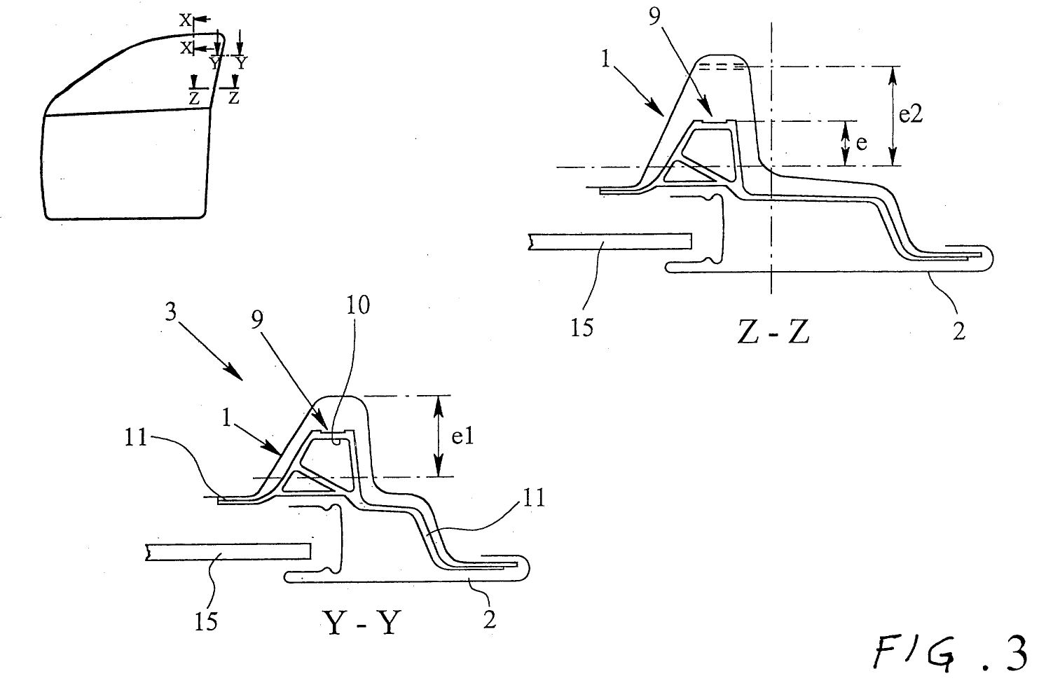

If a door shell of the kind in question is to be produced from aluminium, a stretch-bent aluminium extruded profile 9 with a closed hollow chamber 10 is often used in the region of the window area. This stretch-bent aluminium extruded profile 9 has a constant cross-section over the length and often has integrated functional grooves or flanges 11 projecting outwards. This is shown by the sections in FIG. 3. The formation of the extruded profile 9 of aluminium with a closed hollow chamber 10 is necessary, because the lower E-modulus of aluminium requires a structural design of the frame part 3 that is stiffer as far as deformation is concerned.

A drawback in both cases, i.e. both with steel and with aluminium or other light metal, is the fact that, in most cases, at any rate in the region of B-pillar 8, a side door of a motor vehicle as such has a non-constant thickness, but one which rather becomes larger towards the bottom. This thickness may also diminish again right at the bottom of the body. In the central region, the motor vehicle door often has the greatest thickness, where many functional parts are also fitted on the equipment holder in the door shell. FIG. 3 shows how the thickness of the motor vehicle door already increases from top to bottom in the region of the window area (from section Y-Y to section Z-Z). Inner door panel 1 arches farther inwards in section Z-Z than in section Y-Y.

Furthermore, problems arise with the jointing technique on account of unfavourable geometric conditions in respect of the optimum positioning of frame part 3 and corresponding doorframe reinforcements.

Altogether, existing structural space, which in itself could be used to increase the torsional rigidity, is wasted. This can be seen by the available edge fibre distance dimension e2 in section Z-Z of FIG. 3 (cf. e1 in section Y-Y) as compared with the actually used edge fibre distance dimension e of aluminium extruded profile 9 used there. Occasionally, an attempt is made to utilise this hollow space by means of reinforcing parts additionally fitted to extruded profile 9. This too, however, is not a convincing solution. The term “edge fibre distance dimension”, and in particular the term “fibre”, is a technical term used in doorframe manufacturing in Germany. The term indicates that there is a reference plane in the profile which is located more or less at the same position over the complete length of the profile, and the outer edge of the profile is measured against this reference plane. This distance measured against the reference plane is indicated as e1, e2, e3 in the drawings. This term is also understood to include such terms as “lateral dimension of the inner door panel against a reference plane” and “lateral dimension of the extruded profile against the reference plane”.

According to the invention, a different approach to a solution is taken, which also permits the use of other jointing techniques, in particular bonding of the components of the door shell. The fundamental idea of the teaching is to design the cross-section of profile frame 12 in a varying manner over the length of the profile frame 12 in the area of the non-constantly running region of inner door panel 1, i.e. of the changing thickness of the door shell, e.g. in the region of the B-pillar, the A-pillar or the C-pillar (FIG. 2), in such a way that the overall cross-section of profile frame 12 follows the cross-section of inner door panel 1 or, at least in the thickness, is matched in sections to the thickness of the door shell.

According to the invention, therefore, profile frame 12 of the door shell is first bent to its outer contour and, in a subsequent work operation, is widened according to the requirements for the desired final external shape, preferably by means of a hydraulic internal high-pressure forming process. The closed hollow chamber 10 of profile frame 12, after manufacturing and bending of the profile frame 12, is subjected to a further manufacturing step which changes the outer shape of the hollow chamber 10. This is the result that shall be seen in the final product. With this result in mind the technician of average skills may look out for other manufacturing methods that lead to the same result. One alternative for example is to manufacture the profile frame 12 from two semi-shells, manufacturing those two semi-shells as sheet metal parts in their final shape, and then to join both semi-shells with each other, in particular to weld both shells to form the final closed hollow chamber 10.

A further alternative to realise the above mentioned fundamental idea is discussed later.

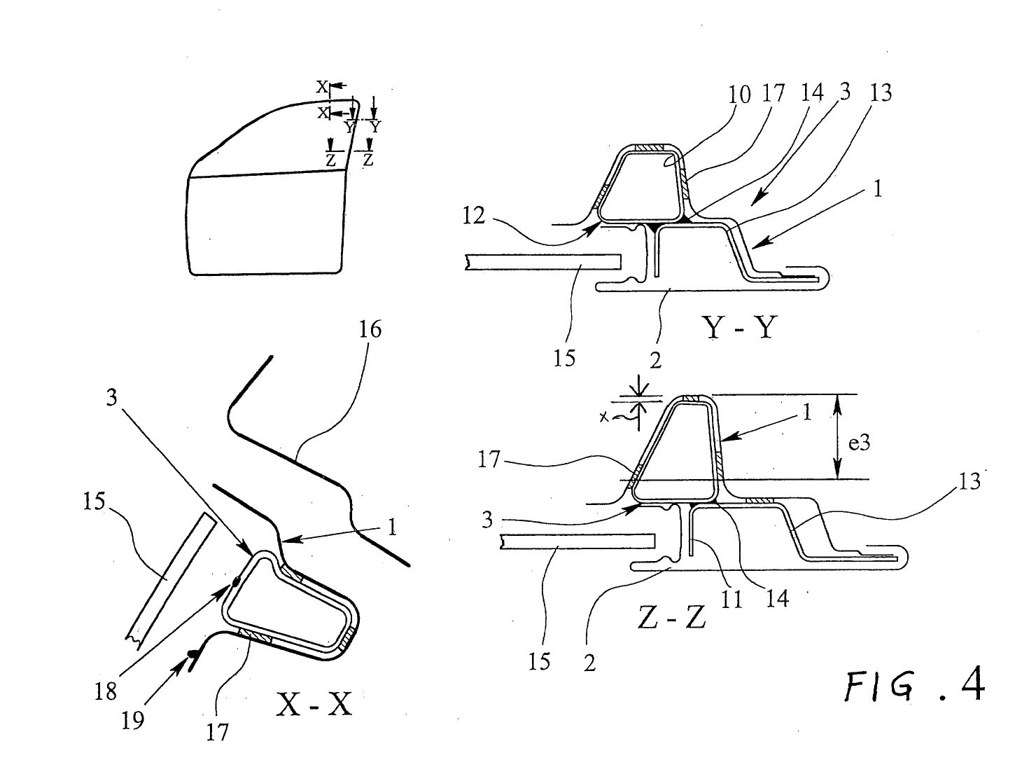

In terms of design, the effect of the invention is that profile frame 12 has an almost surface-parallel contour to the inner surface of inner door panel 1 over a distance x (FIG. 4, all three sections). The existing structural space in respect of the edge fibre distance dimension is used to optimum effect (e3 in Z-Z of FIG. 4). The door shell is stiffened to the optimum degree at least in the region of the window area by means of profile frame 12, full use being made of the door shell thickness available at the given point, said thickness varying over the height of, for example, the B-pillar.

In the embodiment the cross-section of profile frame 12 is closed, with the formation of the represented hollow chamber 10. This closed basic form can be modified to be round, oval, with rounded corners etc. The hollow chamber 10 is closed in the present embodiment, because only a closed hollow chamber 10 allows the application of the preferred hydraulic internal high-pressure forming process. If another manufacturing process is applied different forms of the hollow chamber 10 may be realised. In the embodiment the profile frame 12 carries an open, stretch-bent extruded profile 13 that realises, for example by means of flanges 11, mounting points for other elements. This further extruded profile 13 is welded to the profile 12 at the welding seams 14. The further profile 13 may as well be a press-formed part.

The sections in FIG. 4 indicate the window panel 15 as well as the roof edge 16 (section X-X).

In the embodiment, wall thicknesses between 1.5 and 3.5 mm are stated by way of suggestion for an aluminium profile frame 12. The gap between the inner face of inner door panel 1 and the outer face of profile frame 12 defined by dimension x in FIG. 4 should be between 0.2 and 2.0 mm, preferably below 1.0 mm.

According to the invention, it is of particular importance that the design of profile frame 12 in the door shell makes it possible to comply very precisely with the intended gap widths. As a result, it is possible here to work throughout with a bonding technique as the jointing technique, the corresponding structural adhesive beads 17 being drawn in FIG. 4. At many points, therefore, it is possible to dispense with jointing techniques such as welding, which work with heat, for the assembly of the door shell, so that component distortion and component tolerances can also be kept within limits.

Jointing tolerances can be further minimised by treating the bonding gap as if it were a variable buffer which is capable of compensating proportionally for jointing tolerances that arise. At the time of jointing the subassembly frame part 3 with profile frame 12 with inner door panel 1, account must be taken of the fact that the support reference point 18 of frame part 3, i.e. profile frame 12 here, is on the outside of the component (section X-X of FIG. 4). Corresponding support reference point 19 of inner door panel 1 is also on this side. Consequently, the assembly tolerances occur in the region of the bonding gap with structural adhesive 17.

Profile frame 12 for reinforcing inner door panel 1 has, according to a preferred embodiment, a hollow chamber 10 which is formed in an extruded profile (aluminium) or a tube (aluminium or steel) welded on a longitudinal seam. It is essential for the teaching that the cross-section of profile frame 12 changes in sections over the length of profile frame 12, so that hitherto unused hollow spaces remaining in inner door panel 1 can now be used for better stiffening of the door shell. At the same time, it is possible, on account of the small gap widths that can be produced over the whole length of the profile frame 12 between profile frame 12 and inner door panel 1, to glue inner door panel 1 overall with profile frame 12. A preliminary fixation of the parts that shall be glued to each other later can be realised by mechanical jointing techniques like fastening with rivets.

In addition, of course, there are also bead connections, and partly there are also sections in which a weld seam is placed.

Apart from the particularly widespread metals aluminium and steel, other light metal compounds, e.g. including magnesium, also fall within the scope of the invention.

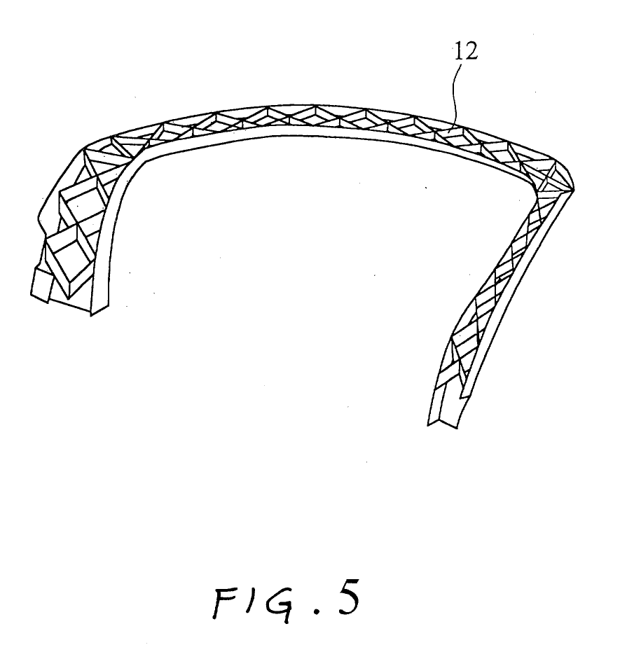

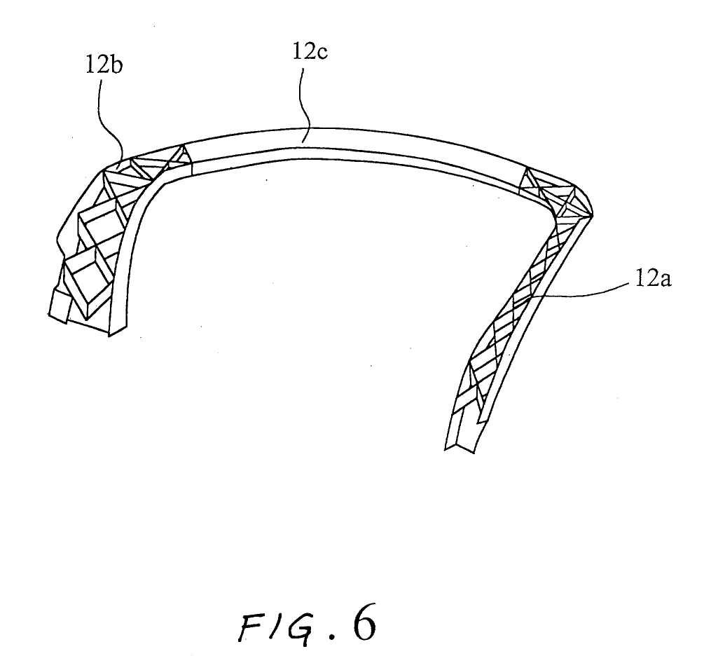

FIG. 5 and 6 show two other alternatives for the profile frame 12. FIG. 5 discloses a profile frame 12 which at least in the region of the window area encloses this area on three sides and is manufactured as a single light metalcasting, in particular an aluminium die cast part. It has been realised that a cast part can as well have a cross-section of the profile frame 12 that is varying over the length of the profile frame 12. FIG. 5 shows the die cast part in a schematic way only and indicates that the profile frame 12 has inner stiffening ribs that are widely used in die-casting. The narrow sides of the stiffening ribs together form an outer envelope and present the places to apply the adhesive to attach the inner door panel 1 to the profile frame 12 by adhesive bonding. Such a profile frame 12 made as a cast part, in particular die cast part, can be provided with stiffening ribs not only on one side but on two sides or all sides.

FIG. 6 shows an alternative to the embodiment of FIG. 5 where only the parts of the profile frame 12 close to the A-pillar and the B-pillar are made as cast parts 12a, 12b, whereas the middle part 12c which shows no varying cross-section is made as a traditional extruded profile and is attached to the other parts 12a, 12b by usual techniques, in particular adhesive bonding, mechanical joints and/or welding. Of course, the above-explained alternatives for the selection of material apply here as well.

I claim:

1. A door shell for a motor vehicle door with a one-piece or multi-piece profile frame (12) of metal characterized in that the profile frame (12) has a profile cross-section changing over the length of the profile frame (12) at least in sections, in particular in the region of an edge of the door shell running essentially vertically.

2. The door shell according to claim 1, characterised in that the profile frame (12) has a hollow chamber (10) and that in particular this hollow chamber (10) has a profile cross-section that changes over the length of the profile frame (12).

3. The door shell according to claim 1, characterised in that the profile frame (12) runs around at least in the region of a window area of the door shell.

4. The door shell according to claim 2, characterised in that the profile frame (12) is designed as an extruded profile of a light metal or light metal compound, in particular aluminium or an aluminium compound, as a tube of a light metal or light metal compound, in particular aluminium or an aluminium compound, welded on a longitudinal seam, as a tube of steel welded on a longitudinal seam, or as a tube of steel produced seamless.

5. The door shell according to claim 1 comprising an inner door panel (1) which has, in particular in the region of an edge of the door shell running essentially vertically, a varying edge fibre distance dimension, characterised in that the profile cross-section of the profile frame (12) is adapted to or follows the form of the inside door panel (1).

6. The door shell according to claim 5, characterised in that between the inner face of the inner door panel (1) and the outer face of the profile frame (12) a small gap (x) exists.

7. The door shell according to claim 6, characterised in that the width of the gap (x) is between 0.2 mm and 2.0 mm, preferably below 1.0 mm.

8. The door shell according to claim 5, characterised in that the inside door panel (1) is attached to the profile frame (12), at least partly, my means of adhesive bonding.

9. The door shell according to claim 6, characterised in that the inside door panel (1) is attached to the profile frame (12), at least partly, my means of adhesive bonding.

10. The door shell according to claim 8, characterised in that those sections of the inside door panel (1) and of the profile frame (12) which are to be jointed by adhesive bonding are additionally fixed relative to each other by means of a mechanical fixation, in particular by rivets.

11. The door shell according to claim 1, characterised in that the wall thicknesses of a profile frame (12) made from aluminium or another light metal or a light metal compound lies between 1.0 and 3.5 mm.

12. The door shell according to claim 2, characterised in that the profile frame (12) with a closed hollow chamber (10) is supplemented by an open profile, which is manufactured as an extruded profile (13), and is connected therewith in particular by welding, wherein the supplemented profile (13) has flanges (11) or other attachment means.

13. The door shell according to claim 1, characterised in that the profile frame (12) is manufactured as a single unitary light metal casting, in particular an aluminium die cast part.

14. The door shell according to claim 1, characterised in that the profile frame (12) is manufactured as a multi-part-unit and is made from cast parts (12a, 12b), in particular aluminium die-cast-parts, where the profile cross-section is changing over its length, whereas it is otherwise manufactured in a traditional way, in particular as an extruded profile.

15. A profile frame for a door shell of a motor vehicle door with a hollow chamber (10) running over its length, wherein the profile frame (12) has a profile cross-section changing over the length of the profile frame (12) at least in sections, in particular in the region where the profile frame (12) when mounted in a door shell or a motor vehicle will follow an edge of the door shell running essentially vertically.

16. The profile frame according to claim 15, characterized in that the profile frame (12) has a hollow chamber (10) and that in particular this hollow chamber (10) has a profile cross-section that changes over the length of the profile frame (12).

17. The profile frame according to claim 15, characterized in that the profile frame (12) runs around at least in the region of a window area of the door shell.

18. The profile frame according to claim 15, characterized in that the wall thicknesses of a profile frame (12) made from aluminium or another light metal or a light metal compound lies between 1.0 and 3.5 mm.

19. The profile frame according to claim 15, characterized in that the profile frame (12) with a closed hollow chamber (10) is supplemented by an open profile, which is manufactured as an extruded profile (13), and is connected therewith in particular by welding, wherein the supplemented profile (13) has flanges (11) or other attachment means.

20. The profile frame according to claim 15, characterized in that the profile frame (12) is manufactured as a single unitary light metal casting, in particular an aluminium die cast part.

21. The profile frame according to claim 15, characterized in that the profile frame (12) is manufactured as a multi-part-unit and is made from cast parts (12a, 12b), in particular aluminium die-cast-parts, where the profile cross-section is changing over its length, whereas it is otherwise manufactured in a traditional way, in particular as an extruded profile.

22. A process for the production of a door shell for a motor vehicle door, in which an inner door panel is first produced in an appropriate manner, in particular is pressed into its final shape from sheet metal, characterized in that the profile frame is produced as a one-piece or a multi-piece part from metal, the profile frame is formed with a profile cross-section changing over the length of the profile frame at least in sections, in particular in the region of an edge of the door shell running essentially vertically, which cross-section is largely matched to the shape of the inner door panel in the corresponding region, and the profile frame is finally assembled and jointed to the inner door panel.

23. A process according to claim 22, characterised in that the profile frame is produced with formation of a hollow chamber and is bent into a contour following the shape of the inner door panel.

24. A process according to claim 22, characterised in that the profile frame is manufactured as a single, unitary light-metal cast part, in particular an aluminium die-cast-part.

25. A process according to claim 22, characterised in that the profile frame is manufactured as a multi-part-unit and is manufactured as light-metal cast parts, in particular as aluminium die-cast-parts, in those regions with a profile cross-section that is changing over the length of the profile frame.

26. A process according to claim 22, characterised in that the profile frame and the inside door panel are jointed by adhesive bonding at least in the regions where there is only a small gap between those parts.

27. A process for the production of a profile frame for a door shell of a motor vehicle door, whereby the profile frame is first produced as a whole from metal with the formation of a hollow chamber and is bent into its contour, in particular for use in a process according to claim 23, characterised in that the final profile cross-section of the profile frame is produced with a hydraulic internal high-pressure forming process, preferably after the bending of the profile frame into its general contour.

28. The process according to claim 27, characterised in that the profile frame is produced as an extruded profile of light-metal or a light-metal compound, preferably aluminium/aluminium compound, as a tube of light-metal or a light-metal compound, preferably aluminium/aluminium compound welded on a longitudinal seam, as a tube of steel welded on a longitudinal seam, or as a tube of steel produced seamless.

29. The process according to claim 27, characterized in that the profile frame with the hollow chamber is supplemented by an open profile, in particular an extruded profile, the open profile being connected to the profile frame preferably by welding, wherein the supplemented profile has flanges or other attachment means, and that the jointing of the profile frame and the inside door panel is done only after connecting the supplemented profile to the profile frame.
